(19) United States
(12) Patent Application Publication
(10) Pub. No.: US 2023/0083892 A1
(43) Pub. Date: Mar. 16, 2023

(54) POPULATION-BASED BLACK-BOX OPTIMIZATION

(71) Applicant: Google LLC, Mountain View, CA (US)

(72) Inventors: David Benjamin Belanger, Cambridge, MA (US); Georgiana Andreea Gane, Mountain View, CA (US); Christof Angermueller, Mountain View, CA (US); David W. Sculley, II, Pittsburgh, PA (US); David Martin Dohan, San Francisco, CA (US); Kevin Patrick Murphy, Palo Alto, CA (US); Lucy Colwell, Cambridge, MA (US); Zelda Elaine Mariet, Cambridge, MA (US)

(21) Appl. No.: 17/798,024

(22) PCT Filed: Feb. 8, 2021
(86) PCT No.: PCT/US2021/017117

§ 371 Date: Aug. 5, 2022

Related U.S. Application Data
(60) Provisional application No. 62/971,905, filed on Feb. 7, 2020.

(51) Int. Cl. G06Q 40/02; G06K 9/62

(52) U.S. Cl. CPC G06Q 40/025; G06K 9/6277

(57) ABSTRACT

Methods and systems for performing black box optimization to identify an output that optimizes an objective.

### CROSS-REFERENCE TO RELATED APPLICATION

This application claims priority to U.S. Provisional Patent Application Ser. No. 62/971,905, filed on Feb. 7, 2020, the entirety of which is hereby incorporated by reference.

### BACKGROUND

This specification relates to black box optimization.

Black box optimization refers to optimization techniques that seek to find an output that optimizes an objective while treating the objective as a “black box,” i.e., while only being able to observe the results of evaluating the objective for any given candidate output.

### SUMMARY

This specification describes a system implemented as computer programs on one or more computers in one or more locations that optimizes an objective through black box optimization.

The subject matter described in this specification can be implemented in particular embodiments so as to realize one or more of the following advantages.

Conventional techniques for batched black box optimization are sensitive to hyper-parameter settings and are therefore not robust enough to be effectively transferred to new optimization problems. Additionally, conventional techniques tend to generate batches of candidate outputs that are similar to one another and therefore cannot evaluate diverse candidate outputs within a single batch. The described techniques, on the other hand, generate batches of outputs by sampling from an ensemble of methods. The number of sequences sampled from any method is proportional to the quality of outputs it previously proposed. This allows the described techniques to combine the strengths of individual methods while hedging against their innate brittleness. This allows the described techniques to discover a high-quality solution in a relatively small number of iterations. This can be particularly advantageous when the evaluation of a candidate output is expensive, time consuming, or consumes significant computational resources. In these cases, using the described techniques can greatly reduce the number of iterations that are required to find a quality solution relative to conventional approaches.

The details of one or more embodiments of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1A shows an example black box optimization system.

FIG. 1B shows examples of iterations of the black box optimization process being performed.

FIG. 2 is a flow diagram of an example process for performing an iteration of the black box optimization process.

FIG. 3 is a flow diagram of an example process for selecting optimization algorithms at a given iteration of the black box optimization process.

Like reference numbers and designations in the various drawings indicate like elements.

### DETAILED DESCRIPTION

This specification describes a black box optimization system implemented as one or more computer programs on one or more computers in one or more locations that determines an input that optimizes, i.e., minimizes or maximizes, a black box objective. In other words, the system optimizes an objective through black box optimization.

In particular, the described techniques can be used to optimize any objective where at each iteration a batch of candidate outputs are evaluated on the objective.

As one particular example, the candidate outputs can be biological sequences, e.g., a DNA sequence or a protein sequence and the objective can measure the result of a wet-lab experiment performed on the biological sequence or of an in silico experiment performed on the biological sequence, e.g., to determine whether the DNA sequence or protein sequence has a desired property. As a particular example, the biological sequences can be DNA sequences and the objective can be to find the DNA sequence that maximizes a binding activity score with a variety of human transcription factors, as measured by either a wet lab experiment or an in silico experiment. As another particular example, the biological sequences can be protein sequences and the objective can be to find the protein that maximizes a binding affinity score with a target molecule, as measured by either a wet lab experiment or an in silico experiment.

As another particular example, the candidate outputs can be different hyper-parameter values for a set of hyper-parameters of a machine learning training algorithm and the objective can measure the fitness or performance of a model trained using the machine learning training algorithm with a particular set of hyper-parameter values. As a particular example, the candidate outputs can be hyper-parameter values for a training process for training a neural network configured to perform an image understanding task on an input image, e.g., image classification, object detecting, semantic segmentation, and so on.

As another particular example, the candidate outputs can be specify different architectures for a neural network that is configured to perform a particular task, e.g., an image understanding task that requires processing an input image to generate an output characterizing the image, e.g., an image classification output, an object detection output, or an image segmentation output. In this example, the black box objective can measure the fitness or performance of a neural network having the architecture specified by the candidate output after being trained on training data for the particular task.

As another particular example, the candidate outputs can specify different hardware architectures for an application-specific integrated circuit (ASIC) and the objective can measure the performance of an ASIC having the architecture, e.g., one or more of any of latency, throughput, power consumption, or design cost. As a particular, example the ASIC can be a special-purpose hardware accelerator for training neural networks.

As another particular example, the candidate outputs can specify different manufacturing processes for manufacturing a product and the objective can measure the efficiency, e.g., in terms of power consumption or cost, of the manufacturing process.

As another particular example, the objective can measure the efficiency of an energy grid and the candidate outputs can be different settings for the energy grid. As another particular example, the objective can measure the performance of traffic system, e.g., in terms of total travel time for users of the traffic system, and the candidates can be different possible configurations of the traffic system.

As another particular example, the objective can measure certain properties of a material, and the candidates can be different possible compositions of the material.

More generally, a black box objective is a function for which the closed form is not known, but that can be evaluated at a query point in the domain of the function. That is, while the closed form of the function is not known, the output generated by the function for a given input can be evaluated.

When applying the described techniques, at each iteration of the optimization process, the system evaluates a batch that includes multiple candidate inputs (i.e., query points) and uses the results of the evaluations as part of optimization process.

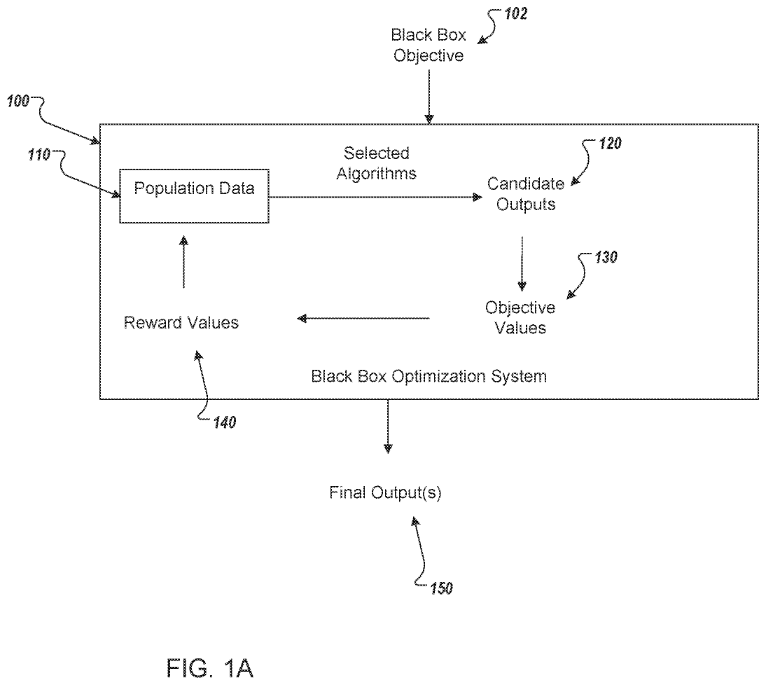

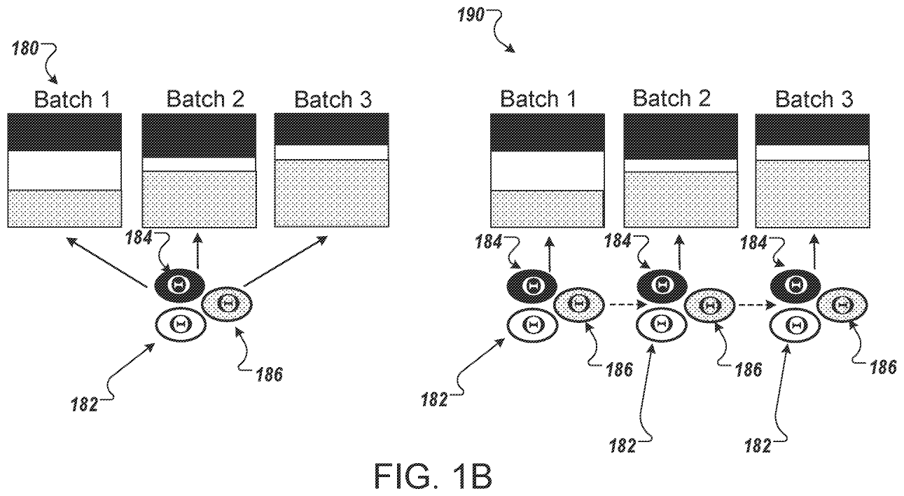

FIG. 1A shows an example black box optimization system 100. The black box optimization system 100 is an example of a system implemented as computer programs on one or more computers in one or more locations, in which the systems, components, and techniques described below can be implemented.

As described above, the black box optimization system 100 is a system that determines one or more optimized inputs that optimize a black box objective by iteratively evaluating batches of multiple candidate optimized outputs on the black box objective.

As one particular example, the candidate outputs can be biological sequences, e.g., DNA sequences or protein sequence, and the objective can measure the result of a wet-lab experiment or in silico experiment performed on the biological sequence.

As another particular example, the candidate outputs can be different hyper-parameter values for a set of hyper-parameters of a machine learning training algorithm and the objective can measure the fitness or performance of a model trained using the machine learning training algorithm with a particular set of hyper-parameter values.

In particular, to identify the output that optimizes the objective, the system 100 maintains population data 110 specifying a population of optimization algorithms and, for each optimization algorithm in the population, one or more respective reward values.

Generally, the population of algorithms can include any set of multiple algorithms that can each independently generate candidate outputs for the black box optimization, i.e., that can generate candidate outputs to be evaluated on the black box objective. For example, the algorithms can include machine learning based approaches, e.g., generative models, evolutionary approaches, random search approaches, and so on.

As a particular example, some evolutionary algorithms perform directed evolutionary search by repeatedly selecting the top k current outputs in an evolutionary population maintained by the algorithm, recombining them, and mutating them to generate a new candidate output.

As another example, some evolutionary algorithms perform the search by, at each iteration, identifying the best candidate output seen so far, and proposing as new candidates some or all of the single-mutation neighbors of the best candidate output.

Machine learning based algorithms can include those that fit, i.e., train, a generative model to maximize the likelihood of high-quality outputs and sample the next batch of candidate outputs from this model.

Another example of a machine learning based algorithm includes model-based optimization (MBO) algorithms. These algorithms automatically tune the hyper-parameters of diverse candidate regressor models. All models with cross-validation performance above a predefined threshold are ensembled, yielding a predicted mean and variance for each candidate output. These are converted into an acquisition function (e.g., expected improvement), which is optimized with regularized evolution to yield the next batch of candidate outputs.

In some cases, each of the algorithms is the same type of algorithm, but with different hyper-parameters. For example, each of the algorithms can be an evolutionary algorithm, but with different hyper-parameters: values for the crossover rate that is used in recombining candidates and the mutation rate that is used in mutating candidates. As another example, each of the algorithms can be an MBO algorithm, but with different hyper-parameters, e.g., with one or more of: different regressors, different acquisition functions, or different mutation rates for the regularized evolution process. As yet another example, each of the algorithms can be a generative-model based algorithm, but with different hyper-parameters, e.g., different architectures for the generative model or different hyper-parameters for the training of the generative model or both.

In some other cases, the algorithms include multiple different types of algorithms, e.g., both evolutionary algorithms and machine learning based algorithms, each with respective settings for the hyper-parameters.

In the example where the objective measures the result of a wet-lab experiment or an in silico experiment, the algorithms can be any appropriate algorithm that can independently generate a biological sequence on which the wet-lab experiment or in silico experiment can be performed.

In the example where the objective measures the fitness of a trained model, the algorithms can be any appropriate algorithm that can independently generate values of a set of hyper-parameters.

As will be described in more detail below, each reward value for a given algorithm corresponds to an already completed iteration of the black box optimization and measures the performance of the algorithm at the corresponding iteration.

The system 100 then performs the optimization over multiple iterations. At each iteration, the system 100 generates a batch of candidate outputs 120 for the iteration by selecting optimization algorithms based on the reward values in the population data 110 and using the selected optimization algorithms to generate the candidate outputs 120 for the batch. Generally, a batch is a fixed number of (unique) candidate outputs. For example, when the outputs are biological sequences, the system 100 can generate each candidate output 120 as a sequence with each element of the sequence being selected from a vocabulary of possible elements, e.g., a vocabulary of size 4 for DNA sequences or a vocabulary of size 20 for proteins. When the outputs are hyper-parameter settings, the system 100 can generate each candidate output 120 as a sequence with each element of the sequence being a respective value for one of the hyper-parameters.

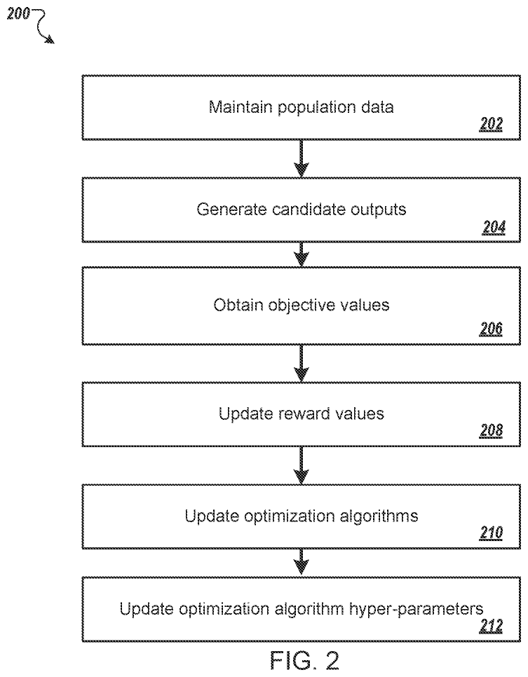

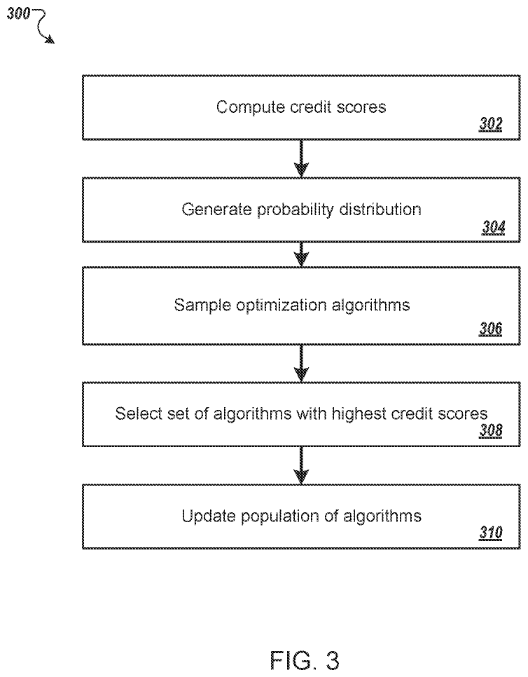

Generating a batch of candidate outputs 120 is described in more detail below with reference to FIGS. 2 and 3.

The system 100 then evaluates the objective for each of the candidate outputs 120 in the batch to generate a respective objective value 130 for each of the candidate outputs. In other words, the system 100 evaluates the black box objective for each of the candidate outputs 120 to generate the respective objective values 130.

When the candidate outputs are biological sequences and the objective measure the result of a wet-lab experiment or in-silico experiment performed on the biological sequence, the objective values 130 are the results of the wet-lab experiment for the corresponding candidate outputs 120, e.g., binding affinity scores or binding activity scores.

As another particular example, when the candidate outputs are different hyper-parameter values for a set of hyper-parameters of a machine learning training algorithm, the objective values 130 are the fitnesses or other measures of performance of a model trained using the machine learning training algorithm with the particular set of hyper-parameter values specified by the corresponding candidate outputs 120.

The system then updates the respective reward values 140 for the optimization algorithms in the population data 110 based on the respective objective values 130 for the candidate outputs 120.

Thus, the system 100 determines how frequently candidate outputs are generated by different algorithms based on how well previously proposed outputs from those algorithms have performed on the objective, as reflected in the reward values in the population data 110.

The system 100 also updates each of the optimization algorithms using the objective values 130 for the candidate outputs 120.

That is, the system 100 updates each optimization algorithm using all of the candidate outputs 120 in the batch, i.e., instead of just updating each particular optimization algorithm only using any candidate output(s) that were generated using the particular optimization algorithm.

The manner in which the system 100 updates a given optimization algorithm is dependent on the type of algorithm.

For example, for algorithms that use machine learning models to generate candidate outputs, the system 100 can train the model using the (candidate output, objective value) pairs as training data for the model.

As another example, for algorithms that use evolutionary search, the system 100 can update the performance measures, i.e., the measures the algorithm uses to determine which are the current best candidate outputs, of the candidates in the evolutionary population maintained by the evolutionary search algorithm.

Thus, during black box optimization, the system 100 repeatedly updates both the algorithms in the population to cause the algorithms to generate improved candidate outputs and the likelihood that each algorithm is used to select the outputs that will be evaluated on the black box objective.

Optionally, during black box optimization, the system 100 can also repeatedly update the hyper-parameters of the algorithms in the population. Updating these hyper-parameters is described in more detail below with reference to FIG. 3.

Once the multiple iterations have been performed, the system 100 can select a final output 150 or a final set of multiple outputs 150, e.g., by selecting the candidate outputs that had the highest objective values during the course of the optimization.

The system 100 can determine how many iterations to perform using any of a variety of criteria. For example, the system 100 can perform iterations until a fixed number of iterations have been performed. As another example, the system 100 can perform iterations until a specified amount of time has elapsed or until a candidate output that has an objective value that exceeds a threshold value has been evaluated.

FIG. 1B shows two examples 180 and 190 of three iterations of the black box optimization process being performed.

In particular, both examples 180 and 190 show three iterations 1, 2, and 3 of the black box iteration process being performed, with fixed size batches (batch 1, batch 2, and batch 3, respectively) of candidate outputs being generated by three different optimization algorithms 182, 184, and 186 at each iteration.

In example 180, the three optimization algorithms 182, and 184, and 186 do not change, but the fraction of candidates in each batch that were generated using each of the three algorithms varies across batch 1, batch 2, and batch 3 based on the quality, as measured by reward values, of candidate outputs that each algorithm has proposed at previous iterations. For example, the fraction of candidates that were proposed by algorithm 186 increases at each of the three iterations, indicating that the algorithm 186 has been generating higher quality candidates relative to the other two algorithms.

In example 190, the three optimization algorithms 182, 184, and 186 also change by having their hyper-parameters updated at each of the three iterations 1, 2, and 3. Thus, in example 190, not only do the fractions of candidates in each batch change to favor candidates proposed by higher quality algorithms, but the hyper-parameters of the algorithms change to favor hyper-parameter settings that have resulted in higher quality candidate outputs being generated at previous iterations.

FIG. 2 is a flow chart of an example process 200 for performing an iteration of the black box optimization. For convenience, the process 200 will be described as being performed by a system of one or more computers located in one or more locations. For example, a black box optimization system, e.g., the black box optimization system 100 of FIG. 1A, appropriately programmed in accordance with this specification, can perform the process 200.

The system maintains population data specifying a population P of optimization algorithms {A₁, . . . , A_{N}} and, for each optimization algorithm Aᵢ in the population, one or more respective reward values r (step 202).

As described above, the respective reward value(s) for any given optimization algorithm are derived from the objective values determined for previous candidate outputs generated by the given optimization algorithm. In some implementations, the system maintains only a single reward value, i.e., the most-recently generated reward value, for any given optimization algorithm. In some other implementations, however, the system maintains multiple reward values for any given optimization algorithm. For example, the system can record each previous reward value that has been generated for the algorithm at any preceding iteration or can record each previous reward value that has been generated within a threshold number of most recent iterations.

The system generates a batch X^{t} of candidate outputs x for the iteration t using the reward values for the optimization algorithm in the population (step 204).

In particular, the system generates the batch by repeatedly, i.e., until a specified number B of candidate outputs have been generated, selecting, based on the reward values for the optimization algorithms in the population, an optimization algorithm, and generating a candidate output using the selected optimization algorithm.

Generally, to select the optimization algorithms, the system computes, based on the reward values, a probability distribution p^{t} over the optimization algorithms in the populations. For example, the probability distribution can be a Categorial distribution. For each selection, the system then samples an optimization algorithm i from the probability distribution.

Selecting an optimization algorithm and generating an output using the selected optimization algorithm are described in more detail below with reference to FIG. 3.

To avoid potentially computationally expensive evaluation of duplicate candidate outputs, the system can determine, for generated candidate output, whether the generated candidate output is a duplicate of another candidate output already in the batch (i.e., if the x is “novel”) and, in response to determining that the generated candidate output is a duplicate, not adding the generated candidate output to the batch.

The system evaluates the objective for each of the candidate outputs in the batch to generate a respective objective value f(x) for each of the candidate outputs x (step 206).

The system updates the respective reward values for the optimization algorithms, i.e., for each optimization algorithm that was used to generate at least one candidate output in the batch, based on the respective objective values for the candidate outputs (step 208). In other words, the system computes a new reward value r^{t} for each candidate output x.

The system can use any of a variety of techniques for updating the reward values. Generally, however, the reward values measure the performance of the corresponding optimization algorithm relative to the other optimization algorithms in the population.

As a particular example, the system can determine a new reward value for a given optimization algorithm that measures the improvement of the given optimization algorithm relative to earlier iterations.

In particular, the system can determine the new reward value by first determining a maximum objective value of the objective values for the candidate outputs in the batch that were generated using the given optimization algorithm.

The system can then determine a new reward value for the given optimization algorithm based on a difference between (i) the maximum objective value of the objective values for the candidate outputs in the batch that were generated using the given optimization algorithm and (ii) a maximum objective value from among objective values for candidate outputs that were generated using the given optimization algorithm at preceding iterations, e.g., over all previous iterations or a threshold number of most recent iterations. In other words, the reward value rᵢ^{t} for algorithm Aᵢ at iteration t satisfies:

$${r}_{i}^{t} = \frac{max \{ f ( x ) \vert x ∈ {𝒳}_{i}^{t} \} - {f}_{max}}{{f}_{max}} , \qquad ( Eq . 1 )$$

where max{f(x)|x∈xᵢ^{t}} is the maximum objective value of the objective values for the candidate outputs in the subset Xᵢ^{t} of the batch X^{t} that were generated using the given optimization algorithm Aᵢ and fₘₐₓ is the maximum objective value from among objective values for candidate outputs that were generated using the given optimization algorithm at preceding iterations.

The system also updates each of the optimization algorithms using the objective values for the candidate outputs in the batch (step 210).

That is, the system updates each optimization algorithm using all of the candidate outputs [symbol] ^{t} in the batch X^{t}, i.e., instead of just updating each particular optimization algorithm only using any candidate output(s) that were generated using the particular optimization algorithm.

The manner in which the system updates a given optimization algorithm is dependent on the type of algorithm. This updating is referred to in the pseudo-code below as Aᵢ.fit(X, [symbol] ).

For example, for algorithms that use discriminative or generative machine learning models to generate candidate outputs, the system can train the generative or discriminative model using the (candidate output, objective value) pairs as training data for the model.

As another example, for algorithms that use evolutionary search, the system can update the performance measures of the candidates in the evolutionary population maintained by the evolutionary search algorithm.

Optionally, the system can also update the hyper-parameters of one or more of the optimization algorithms in the population (step 212). Updating the hyper-parameters of optimization algorithms is described in more detail below with reference to FIG. 3. This is also referred to as running adapt(P^{t},s^{t}) in the pseudo-code below.

FIG. 3 is a flow chart of an example process 300 for selecting an optimization algorithm. For convenience, the process 300 will be described as being performed by a system of one or more computers located in one or more locations. For example, a black box optimization system, e.g., the black box optimization system 100 of FIG. 1A, appropriately programmed in accordance with this specification, can perform the process 300.

The system computes, for each optimization algorithm in the population, a respective credit score s^{t} from the reward value(s) associated with the algorithm in the population data (step 302). In particular, when there are multiple rewards associated with the algorithm, the credit score depends not only on the most recent rewards but also on the sum of exponentially decayed previous rewards. For example, the credit score sᵢ^{t} at iteration t for the i-th algorithm can satisfy:

Σ_{k≤t}rᵢ^{k}y^{t-k}, (Eq. 2)

where k ranges over any iterations that are before the iteration t for which there is a reward value associated with the algorithm in the population data and γ is a constant value that is between zero and one.

The system computes a probability distribution over the population from the respective credit scores (step 304).

As a particular example, the system normalize, e.g., using min-max normalization, the credit scores to generate normalized credit scores ŝ^{t} . The system can then scale each normalized credit score by dividing it by a temperature parameter τ to generate scaled credit scores and then apply a softmax over the scaled credit scores to generate the probability distribution. Thus, the probability pᵢ for the i-th algorithm satisfies:

$$\frac{exp ( \frac{{\hat{s}}_{i}^{t}}{τ} )}{{\sum }_{j} exp ( \frac{{\hat{s}}_{j}^{t}}{τ} )} , \qquad ( Eq . 3 )$$

The system then repeatedly samples candidate algorithms from the probability distribution and generates candidate outputs using the sampled candidate algorithms (referred to as Aᵢ.propose( )below) until a fixed number B of (unique) candidate outputs have been generated (step 306).

The manner in which the system generates a candidate output using a given optimization algorithm is dependent on the type of algorithm.

For example, for algorithms that use discriminative or generative machine learning models to generate candidate outputs, the system can use the generative or discriminative model (in accordance with the current values of the model weights) to generate the candidate output.

As another example, for algorithms that use evolutionary search, the system can select a candidate output from the evolutionary population based on the performance measures of the candidates in the evolutionary population and then mutate the selected candidate output to generate a new candidate output. As another example, the system can select two candidate outputs from the evolutionary population based on the performance measures of the candidates in the evolutionary population and then apply a crossover transformation to the selected candidate outputs to generate a new candidate output.

As described above, the system can optionally update the hyper-parameters of one or more of the optimization algorithms in the population online, i.e., during the iterations of the optimization algorithms. For example, the system can perform this updating after every N iterations of the optimization algorithm i.e. after every N iterations of the process 200, have been performed, where N is a fixed integer that is greater than or equal to one.

In these cases, the system selects a set of algorithms S with the highest credit scores (step 308). For example, the system can select each algorithm that has a credit score that is higher than a quantile cutoff score q.

The system then updates the population of algorithms, i.e., generates a new, updated population that has updated hyper-parameters, from the selected algorithms using mutation, recombination, or both (step 310).

The system can then repeatedly perform the following operations to generate an updated population that has the same number of algorithms as the existing population.

The system can use tournament selection (tournament.select(S)) to select k=2 parents from the selected algorithms and recombine their hyper-parameters (recombine.parents) to generate an updated algorithm with updated hyper-parameters. If the parents belong to different classes of algorithms and their hyper-parameters are incompatible, the system selects one of them randomly. Otherwise, the system recombines their hyper-parmeters by applying a crossover to their hyper-parameters with a fixed crossover rate. Then, the system mutates the resulting hyper-parameters with a fixed mutation rate by either resampling hyper-parameters values from a prior distribution, or scaling them by a constant. The system then adds the new algorithm with the mutated hyper-parameters to the updated population. For the new algorithm, the system can either copy the rewards from the parent(s) or can initialize a new set of rewards for the new algorithm e.g., by randomly initializing the rewards or by setting the rewards to pre-determined values.

Algorithm 1 below shows pseudo-code for an example of performing T iterations of the black box optimization using the above techniques:

| Algorithm 1 | |
|---|---|
| Input: Population [symbol] = {A₁, . . . , A_{N}} | |
| Input: Softmax temperature τ > 0, | |
| Input: Initial sampling weights p¹ | |
| X, Y = ∅, ∅ | [symbol] Sequences and labels |

| for t = 1 to T do | |
|---|---|
| \| X^{t} = ∅ | |
| \| X [symbol] , . . . , X_{N}^{t} = ∅, . . . , ∅ | |
| \| while \|X^{t}\| ≤ B do | |
| \| \| i ~ Categorical(p [symbol] ) | |
| \| \| α = Aᵢ.propose( ) | |
| \| \| X^{t} ← X [symbol] ∪ {x} | [symbol] Only add x if novel |
| \| \| Xᵢ^{t} ← X [symbol] ^{t} ∪ {x} | [symbol] Only add x if novel |

| \| Y^{t} = {ƒ(x) \| x ∈ Xⁱ} | |
|---|---|
| \| X, Y ← X ∪ X^{t}, Y ∪ Y^{t} | |
| \| r^{t} = get_rewards(X, Y, {Xᵢ^{t}}ᵢ) | [symbol] Eq. 1 |
| \| s^{t} = decayed_rewards(rⁱ) | [symbol] Eq. 2 |

| \| if Adaptive P3BO then | |
|---|---|
| \| \| [symbol] , s^{t} = adapt( [symbol] ^{t}, s^{t}) | [symbol] Alg. 2 |

| | |
|---|---|
| \| p [symbol] ⁺¹ = softmax( [symbol] ^{t}/τ) | [symbol] Eq. 3 |

| for Aᵢ ∈ [symbol] do
| | Aᵢ, [symbol] (X, Y)
return X

[symbol]

indicates data missing or illegible when filed

In Algorithm 1, “adaptive P3BO” refers to the above described technique for updating the hyper-parameters of the optimization algorithms. An example of pseudo code performing “adaptive P3B0” is shown in Algorithm 2 below:

Algorithm 2
Input: Population of algorithms [symbol] = {A₁, . . . , A_{N}}
Input: Algorithm scores s = {s₁, . . . , s_{N}}
Input: Quantile cutoff q
S = {Aᵢ ∈ [symbol] | ƒᵢ ≥ q} [symbol]
, \tilde{s} = ∅, ∅
for i = 1 to N do
| parents = tournament_select(S)
| Aᵢ, sᵢ = recombine(parents)
| Ãᵢ = mutate(A [symbol] )
| [symbol] ← [symbol] ∪ {Ãᵢ}
| \tilde{s} ← \tilde{s} ∪ {sᵢ}
return [symbol] , \tilde{s}

[symbol]

indicates data missing or illegible when filed

This specification uses the term “configured” in connection with systems and computer program components. For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non transitory storage medium for execution by, or to control the operation of, data processing apparatus. The computer storage medium can be a machine-readable storage device, a machine-readable storage substrate, a random or serial access memory device, or a combination of one or more of them. Alternatively or in addition, the program instructions can be encoded on an artificially generated propagated signal, e.g., a machine-generated electrical, optical, or electromagnetic signal, that is generated to encode information for transmission to suitable receiver apparatus for execution by a data processing apparatus.

The term “data processing apparatus” refers to data processing hardware and encompasses all kinds of apparatus, devices, and machines for processing data, including by way of example a programmable processor, a computer, or multiple processors or computers. The apparatus can also be, or further include, special purpose logic circuitry, e.g., an FPGA (field programmable gate array) or an ASIC (application specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program, which may also be referred to or described as a program, software, a software application, an app, a module, a software module, a script, or code, can be written in any form of programming language, including compiled or interpreted languages, or declarative or procedural languages; and it can be deployed in any form, including as a stand alone program or as a module, component, subroutine, or other unit suitable for use in a computing environment. A program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub programs, or portions of code. A computer program can be deployed to be executed on one computer or on multiple computers that are located at one site or distributed across multiple sites and interconnected by a data communication network.

In this specification, the term “database” is used broadly to refer to any collection of data: the data does not need to be structured in any particular way, or structured at all, and it can be stored on storage devices in one or more locations. Thus, for example, the index database can include multiple collections of data, each of which may be organized and accessed differently.

Similarly, in this specification the term “engine” is used broadly to refer to a software-based system, subsystem, or process that is programmed to perform one or more specific functions. Generally, an engine will be implemented as one or more software modules or components, installed on one or more computers in one or more locations. In some cases, one or more computers will be dedicated to a particular engine; in other cases, multiple engines can be installed and running on the same computer or computers.

The processes and logic flows described in this specification can be performed by one or more programmable computers executing one or more computer programs to perform functions by operating on input data and generating output. The processes and logic flows can also be performed by special purpose logic circuitry, e.g., an FPGA or an ASIC, or by a combination of special purpose logic circuitry and one or more programmed computers.

Computers suitable for the execution of a computer program can be based on general or special purpose microprocessors or both, or any other kind of central processing unit. Generally, a central processing unit will receive instructions and data from a read only memory or a random access memory or both. The essential elements of a computer are a central processing unit for performing or executing instructions and one or more memory devices for storing instructions and data. The central processing unit and the memory can be supplemented by, or incorporated in, special purpose logic circuitry. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer readable media suitable for storing computer program instructions and data include all forms of non volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser. Also, a computer can interact with a user by sending text messages or other forms of message to a personal device, e.g., a smartphone that is running a messaging application, and receiving responsive messages from the user in return.

Data processing apparatus for implementing machine learning models can also include, for example, special-purpose hardware accelerator units for processing common and compute-intensive parts of machine learning training or production, i.e., inference, workloads.

Machine learning models can be implemented and deployed using a machine learning framework, .e.g., a TensorFlow framework, a Microsoft Cognitive Toolkit framework, an Apache Singa framework, or an Apache MXNet framework.

Embodiments of the subject matter described in this specification can be implemented in a computing system that includes a back end component, e.g., as a data server, or that includes a middleware component, e.g., an application server, or that includes a front end component, e.g., a client computer having a graphical user interface, a web browser, or an app through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other. In some embodiments, a server transmits data, e.g., an HTML page, to a user device, e.g., for purposes of displaying data to and receiving user input from a user interacting with the device, which acts as a client. Data generated at the user device, e.g., a result of the user interaction, can be received at the server from the device.

While this specification contains many specific implementation details, these should not be construed as limitations on the scope of any invention or on the scope of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claimed combination may be directed to a subcombination or variation of a subcombination.

Similarly, while operations are depicted in the drawings and recited in the claims in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

1. A method of performing black box optimization to identify an output that optimizes an objective, the method comprising, at each of a plurality of iterations:
maintaining data specifying a population of optimization algorithms and, for each optimization algorithm in the population, one or more respective reward values;
generating a batch of candidate outputs for the iteration by repeatedly performing the following:
selecting, based on the reward values for the optimization algorithms in the population, an optimization algorithm, and
generating a candidate output using the selected optimization algorithm;
evaluating the objective for each of the candidate outputs in the batch to generate a respective objective value for each of the candidate outputs; and
updating the respective reward values for the optimization algorithms based on the respective objective values for the candidate outputs.

2. The method of claim 1, wherein the outputs are biological sequences and the objective measures a result of a wet-lab experiment or an in silico experiment using the biological sequence.

3. The method of claim 1, wherein the outputs are hyper-parameters of a machine learning training process and the objective measures a fitness of a machine learning model trained using the hyper-parameters.

4. The method of claim 1, wherein selecting, based on the reward values for the optimization algorithms in the population, an optimization algorithm comprises:
computing, based on the reward values, a probability distribution over the optimization algorithms in the population; and
sampling an optimization algorithm from the probability distribution.

5. The method of claim 4, wherein the reward values include respective rewards for each of one or more previous iterations, and wherein computing, based on the reward values, a probability distribution over the optimization algorithms in the population:
computing a respective credit score for each of the optimization algorithms based on a time discounted sum of the reward values for the optimization algorithm; and
computing the probability distribution from the respective credit scores.

6. The method of claim 5, further comprising:
selecting a set of algorithms with highest credit scores; and
updating hyper-parameters of the algorithms in the population based on the hyper-parameters of the selected algorithms using recombination, mutation, or both.

7. The method of claim 1, wherein updating the respective reward values for the optimization algorithms based on the respective objective values for the candidate outputs comprises, for each optimization algorithm that was used to generate at least one candidate output in the batch:
determining a maximum objective value of the objective values for the candidate outputs in the batch that were generated using the optimization algorithm; and
determining a new reward value for the optimization algorithm based on a difference between (i) the maximum objective value of the objective values for the candidate outputs in the batch that were generated using the optimization algorithm and (ii) a maximum objective value from among objective values for candidate outputs that were generated using the optimization algorithm at preceding iterations.

8. The method of claim 1, further comprising:
updating each of the optimization algorithms using the objective values for the candidate outputs in the batch.

9. The method of claim 1, wherein generating a candidate output using the selected optimization algorithm comprises:
determining whether the generated candidate output is a duplicate of another candidate output already in the batch; and
in response to determining that the generated candidate output is a duplicate, removing the generated candidate output from the batch.

10. (canceled)

11. One or more non-transitory computer storage media storing instructions that when executed by one or more computers cause the one or more computers to perform operations for performing black box optimization to identify an output that optimizes an objective, the method comprising, at each of a plurality of iterations:
maintaining data specifying a population of optimization algorithms and, for each optimization algorithm in the population, one or more respective reward values;
generating a batch of candidate outputs for the iteration by repeatedly performing the following:
selecting, based on the reward values for the optimization algorithms in the population, an optimization algorithm, and
generating a candidate output using the selected optimization algorithm;
evaluating the objective for each of the candidate outputs in the batch to generate a respective objective value for each of the candidate outputs; and
updating the respective reward values for the optimization algorithms based on the respective objective values for the candidate outputs.

12. The computer storage media of claim 11, wherein the outputs are biological sequences and the objective measures a result of a wet-lab experiment or an in silico experiment using the biological sequence.

13. A system comprising one or more computers and one or more storage devices storing instructions that when executed by the one or more computers cause the one or more computers to perform operations for performing black box optimization to identify an output that optimizes an objective, the method comprising, at each of a plurality of iterations:
maintaining data specifying a population of optimization algorithms and, for each optimization algorithm in the population, one or more respective reward values;
generating a batch of candidate outputs for the iteration by repeatedly performing the following:
selecting, based on the reward values for the optimization algorithms in the population, an optimization algorithm, and
generating a candidate output using the selected optimization algorithm;
evaluating the objective for each of the candidate outputs in the batch to generate a respective objective value for each of the candidate outputs; and
updating the respective reward values for the optimization algorithms based on the respective objective values for the candidate outputs.

14. The system of claim 13, wherein the outputs are biological sequences and the objective measures a result of a wet-lab experiment or an in silico experiment using the biological sequence.

15. The system of claim 13, wherein the outputs are hyper-parameters of a machine learning training process and the objective measures a fitness of a machine learning model trained using the hyper-parameters.

16. The system of claim 13, wherein selecting, based on the reward values for the optimization algorithms in the population, an optimization algorithm comprises:
computing, based on the reward values, a probability distribution over the optimization algorithms in the population; and
sampling an optimization algorithm from the probability distribution.

17. The system of claim 16, wherein the reward values include respective rewards for each of one or more previous iterations, and wherein computing, based on the reward values, a probability distribution over the optimization algorithms in the population:
computing a respective credit score for each of the optimization algorithms based on a time discounted sum of the reward values for the optimization algorithm; and
computing the probability distribution from the respective credit scores.

18. The system of claim 17, the operations further comprising:
selecting a set of algorithms with highest credit scores; and
updating hyper-parameters of the algorithms in the population based on the hyper-parameters of the selected algorithms using recombination, mutation, or both.

19. The system of claim 13, wherein updating the respective reward values for the optimization algorithms based on the respective objective values for the candidate outputs comprises, for each optimization algorithm that was used to generate at least one candidate output in the batch:
determining a maximum objective value of the objective values for the candidate outputs in the batch that were generated using the optimization algorithm; and
determining a new reward value for the optimization algorithm based on a difference between (i) the maximum objective value of the objective values for the candidate outputs in the batch that were generated using the optimization algorithm and (ii) a maximum objective value from among objective values for candidate outputs that were generated using the optimization algorithm at preceding iterations.

20. The system of claim 13, the operations further comprising:
updating each of the optimization algorithms using the objective values for the candidate outputs in the batch.

21. The system of claim 13, wherein generating a candidate output using the selected optimization algorithm comprises:
determining whether the generated candidate output is a duplicate of another candidate output already in the batch; and
in response to determining that the generated candidate output is a duplicate, removing the generated candidate output from the batch.
